(19) United States
(12) Patent Application Publication
(10) Pub. No.: US 2017/0317936 A1
(43) Pub. Date: Nov. 2, 2017

(54) SELECTIVE STEERING NETWORK TRAFFIC TO VIRTUAL SERVICE(S) USING POLICY

(71) Applicant: Cisco Technology, Inc., San Jose, CA (US)

(72) Inventors: Nagarajan Swaminathan, Fremont, CA (US); Dinesh Ranjit, San Jose, CA (US); Daniel Freedman, Apex, NC (US)

(21) Appl. No.: 15/140,870

(22) Filed: Apr. 28, 2016

(51) Int. Cl. H04L 12/813; H04L 29/12; H04L 12/741; H04L 29/06; H04L 12/725

(52) U.S. Cl. CPC H04L 47/20; H04L 69/22; H04L 45/302; H04L 45/74; H04L 61/2592

(57) ABSTRACT

A classifier network element in a service function chain system receives a classification policy and an access policy from a controller of the service function chain system. The classification policy identifies which service function path network traffic flows will traverse through the service function chain system. The access policy defines criteria for determining whether network traffic flows will be sent along a service function path of the service function chain system. The classifier network element receives an initial packet of a network traffic flow from a source endpoint directed to a destination endpoint. Responsive to a determination that the initial packet of the network traffic flow satisfies the criteria of the access policy, the classifier network element applies the access policy to the network traffic flow.

### TECHNICAL FIELD

The present disclosure relates to applying service function chains in networks.

### BACKGROUND

Service Function Chaining enables virtualized networking functions to be implemented as part of a cloud network. A Service Function Chain defines an ordered list of a plurality of service functions (e.g., firewall, compression, intrusion detection/prevention, load balancing, deep packet inspection, etc.) that may be applied to packet flows in the network. A flow enters the network through a classifier node that generates a Service Function Path for that flow according to the Service Function Chain policy. The classifier node encapsulates each packet of the flow with a Network Service Header that indicates the service functions to which the flow will be subjected, and the order the service functions will be applied.

Service Function Chaining and Network Service Headers provide a scalable, extensible, and standardized way of sharing metadata between both network nodes and service nodes within a network topology. This allows for disparate nodes that require shared context, but do not communicate directly, to share that context via metadata within the packets traversing the network or service topology.

### BRIEF DESCRIPTION OF THE DRAWINGS

FIG. 1 is a system block diagram showing a Service Function Chain network environment configured to employ an access policy, according to an example embodiment.

FIG. 2 is a simplified block diagram of a classifier network element within the Service Function Chain network environment, according to an example embodiment.

FIG. 3 is a ladder diagram that shows messages in applying the access policy to send a flow to a service function, according to an example embodiment.

FIG. 4 is a ladder diagram that shows messages in applying the access policy to bypass a service function, according to an example embodiment.

FIG. 5 is a ladder diagram that shows messages in applying the access policy to drop a flow without sending it to a service function, according to an example embodiment.

FIG. 6 is a flowchart depicting the operations of a network element in applying the access policy to a network traffic flow, according to an example embodiment.

### DESCRIPTION OF EXAMPLE EMBODIMENTS

### Overview

A classifier network element in a service function chain system receives a classification policy and an access policy from a controller of the service function chain system. The classification policy identifies which service function path network traffic flows will traverse through the service function chain system. The access policy defines one or more criteria for determining whether network traffic flows will be sent along a service function path of the service function chain system. The classifier network element receives an initial packet of a network traffic flow from a source endpoint directed to a destination endpoint. Responsive to a determination that the initial packet of the network traffic flow satisfies the one or more criteria of the access policy, the classifier network element applies the access policy to the network traffic flow.

### DETAILED DESCRIPTION

Virtual environments may employ Service Function Chain architecture to insert network services in the path of a network traffic flow. Virtual services may be configured on a per port/interface basis in some examples. All traffic ingress and egress to and from a virtual machine with a virtual service enabled on its port will be redirected to the network service. A user does not have control to select which flows will be redirected to the service function and which flows will bypass the service function. The techniques presented herein enable a user to filter traffic to be steered to a virtual service function using one or more access control policies.

Service Function Chaining provides both metadata of a network traffic flow and steers the flow to appropriate service functions. The Service Function Chain encapsulation carries information that identifies a Service Function Path. The Service Function Path comprises an ordered list of service functions that act on the packets in the flow. The overhead in encapsulating the flow may be avoided for certain flows based on a preconfigured access policy that allows the Service Function Chain system to remove itself from flows that do not require any service functions to be performed.

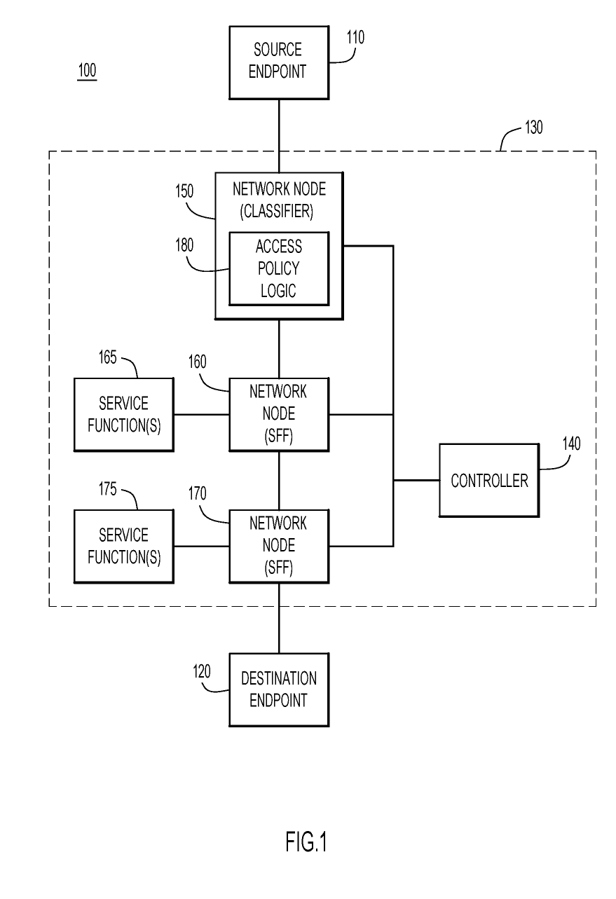

Referring now to FIG. 1, a simplified block diagram of a data flow system 100 between two endpoints is shown. A source endpoint 110 sends a data flow to destination endpoint 120 through the Service Function Chain system 130. Endpoints 110 and/or 120 may include, for example, smart phones, tablets, laptop computers, desktop computers, virtual machine applications running in a datacenter, or other types of computing devices. Service Function Chain system 130 comprises a controller 140 that controls network nodes 150, 160, and 170. Service function nodes 165 and 175 are connected to network nodes 160 and 170, respectively.

As the network node that is connected to the source endpoint 110, the network node 150 acts as a classifier node in the Service Function Chain system 130 for flows originating from source endpoint 110. In other words, the classifier node 150 classifies network traffic flows from the source endpoint 110 into an appropriate Service Function Path. The classifier node 150 also includes access policy logic 180 to determine whether the network traffic flows from the source endpoint 110 should be classified in any Service Function Path at all.

The network nodes 160 and 170 act as Service Function Forwarders (SFFs) in the Service Function Chain system 130 and direct flows that have been classified in Service Function Paths to the appropriate service functions, e.g., service function 165 and/or service function 175. The network nodes 160 and 170 may also perform standard network element functions and carry flows that are not classified into a Service Function Path.

In one example, the SFF nodes 160 and 170 may load balance performance of a service function by sending packets to a plurality of instances of the service function. Alternatively, the service function nodes 165 and 175 attached to each Service Function Forwarder may provide different service functions. In another example, each Service Function Forwarder node 160 or 170 handles all of the instances of a given service function in a Service Function Path. Alternatively, a service function may be repeated at different Service Function Forwarders, e.g., service function node 165 may perform the same service function as service function node 175.

In the example shown in FIG. 1, the Service Function Chain system 130 is shown with one classifier network element, two SFF network nodes, and two service function nodes, but the techniques presented herein may be applied to Service Function Chain systems with any number of SFF network nodes and any number of service functions. Additional network elements, either inside the Service Function Chain system 130 or outside of the system 130 may also be included to transmit the flows between source endpoint 110 and destination endpoint 120. Additional service classifiers may also be included in the Service Function Chain system 130, e.g., to handle return data flows from the destination endpoint 120 to the source endpoint 110.

In another example, one or more of the nodes in the Service Function Chain system 130 may be physical devices or virtual machines running in a data center. Additionally, endpoints (e.g., virtual machines) may be connected to each of the SFF network nodes 160 and 170, and one or more service functions may be connected to the classifier node 150. In general, service function nodes and endpoints may be connected to the same network node, a different network node within the same Service Function Chain system 130, or a separate services platform. When traffic between endpoints (e.g., source endpoint 110 and destination endpoint 120) are redirected through a service function, then the network node (e.g., SFF 160) and the service function node (e.g., service function node 165) may maintain state information for any flows between different endpoints.

In a further example, access policy logic 180 comprises user configurable policies to selectively filter network traffic to be steered to a service function, such as service function 165. A user (e.g., a network manager for the system 130) may configure an access list specifying various actions that may be performed on a matching flow. Flows are classified at the classifier node 150 based on characteristics of the flows. Based on the classification, an appropriate action is marked for execution on the flow. Appropriate actions may include, for example, forwarding the flow to a service function, permitting the flow to bypass the service function, or dropping the flow. Characteristics of the flows that the classifier node 150 may match in the access policy logic 180 may include the protocol of the packets in the flow, the source address, the destination address, type of packets in the flow, Quality of Service (QoS) parameters, port numbers, parameters of the network stack, or any other Layer 2, Layer 3, or Layer 4 attributes of the traffic flows.

In one example, if the user does not want to steer traffic from the source endpoint 110 to any service function in the Service Function Chain system 130, then the user configures access policy 180 as follows, and applies it to classifier node 150:

access-policy bypass

access-list: source host 110, permit flow, bypass service

Additionally, if the user does not want any traffic destined for endpoint 110 to be steered through any service function, the access policy 180 may include a further line of: access-list, destination host 110, permit flow, bypass service

In this example, any traffic to or from endpoint 110 is simply permitted to flow without being sent through any service function. Alternatively, if the user chooses to redirect all traffic through a port to a service function, then the access policy 180 may include a default value that sends all traffic flows through the Service Function Chain system 130.

In another example, the source endpoint 110 and destination endpoint 120 may a client/server pair or front-end/back-end servers in a data center farm. The server port of source endpoint 110 on the network node 150 may be statically configured with a default Service Function Path comprising a set of service functions 165 and 175 (e.g., Deep Packet Inspection, edge firewall services, load balancing, segmentation firewall services, etc.). Access policy logic 180 may identify certain types of network traffic that can bypass the default Service Function Path. For example, Address Resolution Protocol (ARP) traffic to/from the source endpoint 110 and Dynamic Host Configuration Protocol version 6 (DHCPv6) traffic may be allowed to bypass the service functions 165 and 175, while all other network traffic flows are steered through the default Service Function Path, including the service functions 165 and 175.

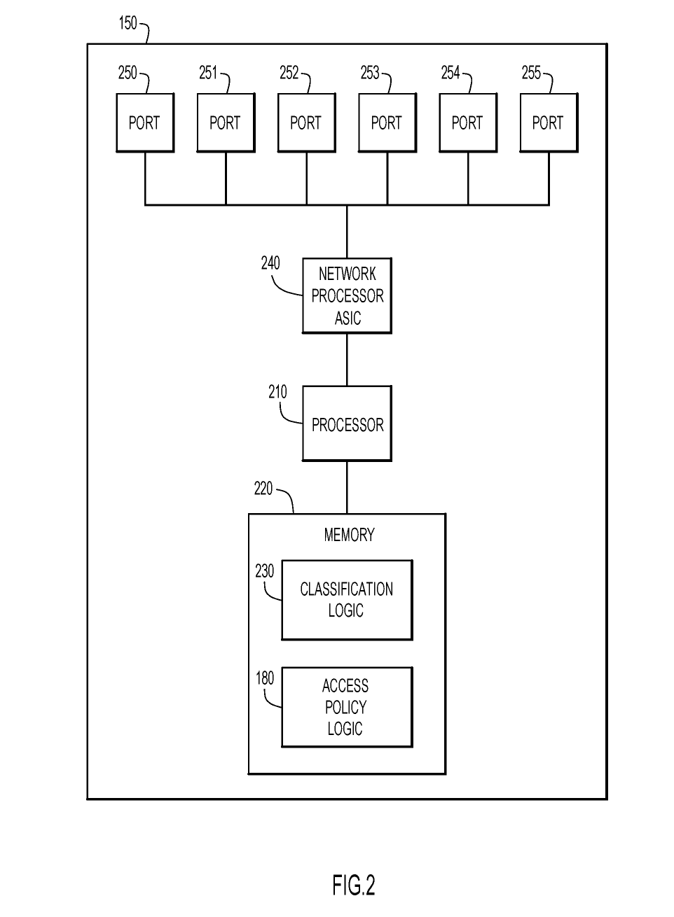

Referring now to FIG. 2, a simplified block diagram is shown of a classifier network device 150 configured to perform the techniques of a classifier node. Classifier 150 includes, among other possible components, a processor 210 to process instructions relevant to processing communication packets for a Service Function Chain system, and memory 220 to store a variety of data and software instructions (e.g., classification logic 230, access policy logic 180, communication packets, etc.). The classifier 150 also includes a network processor application specific integrated circuit (ASIC) 240 to process communication packets that flow through the classifier device 150. Network processor ASIC 240 processes communication packets be sent to and received from ports 250, 251, 252, 253, 254, and 255. While only six ports are shown in this example, any number of ports may be included in classifier device 150.

Memory 220 may include read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may comprise one or more tangible (non-transitory) computer readable storage media (e.g., a memory device) encoded with software comprising computer executable instructions and when the software is executed (e.g., by the processor 210) it is operable to perform the operations described herein.

It is to be understood that the classifier network device 150 may be a physical device or a virtual (software) device. In the latter case, the classifier network device 150 is embodied as software running on a compute node (e.g., in a datacenter or other environment) through which traffic is directed and for which determinations are made as to how packets are to be routed into a Service Function Chain.

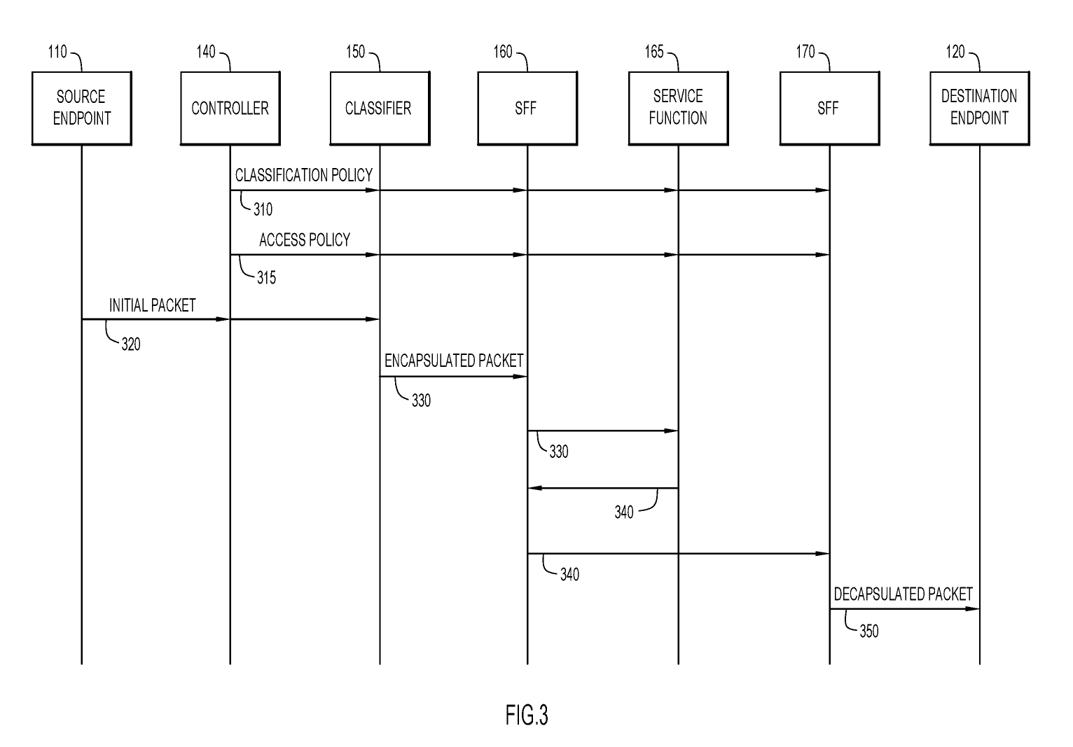

Referring now to FIG. 3, a ladder diagram is shown of messages exchanged in establishing an access policy 180 that directs a flow to a service function. Initially, the controller 140 of the Service Function Chain system 130 sends a classification policy 310 to the classifier node 150. The classification policy 310 indicates which Service Function Paths network flows are to be classified into based on characteristics of the flows. The controller 140 also sends the access policy 315 to the classifier node 150. The access policy 315 identifies whether flows will be classified into any Service Function Path by the classifier node 150 based on characteristics of the flow. The classification policy 310 and the access policy 315 may additionally be sent to the other network nodes (e.g., SFF node 160 and SFF node 170), since each network node may act as a classifier node for different endpoints.

The source endpoint 110 sends an initial packet 320 of a flow from the source endpoint 110 to the destination endpoint 120. The initial packet 320 is received by the classifier node 150, and based on the access policy 315 received from the controller 140, the classifier node 150 determines that the flow initiated by the packet 320 will be processed by a service function in the Service Function Chain system 130. The classifier node 150 may determine that the flow will be sent to a service function based on characteristics of the initial packet 320. For example, the access policy 315 may indicate that flows from the address of the source endpoint 110 are to be steered to a service function.

To steer the initial packet 320 into the Service Function Chain system 130, the classifier node 150 encapsulates the initial packet 320 to generate an encapsulated packet 330. In one example, encapsulated packet 330 comprises a Network Service Header that indicates a Service Function Path on which the packet will travel. The specific Service Function Path is determined by the classifier node 150 according to the classification policy 310. The classifier node 150 forwards the encapsulated packet 330 to the SFF node 160 indicated in the Service Function Path. The SFF node 160 forwards the packet 330 to the service function node 165, which acts on the packet 330 with the selected service function and returns a serviced packet 340. The serviced packet 340 remains encapsulated with the Network Service Header indicating the Service Function Path, and the serviced packet 340 is returned to the SFF node 160. The SFF node 160 forwards the serviced packet 340 to the SFF node 170. The SFF node 170 removes the encapsulation as the packet is leaving the Service Function Chain system, and forwards the decapsulated packet 350 to the destination endpoint 120.

In another example, the SFF node 160 may determine that the service function 165 is the last service function in the Service Function Path, and remove the encapsulation before forwarding the decapsulated packet 350 to the destination endpoint 120 via the SFF node 170. Alternatively, the Service Function Path may include additional service functions (not shown), and the last SFF node in the Service Function Path may remove the encapsulation before forwarding the decapsulated packet 350 to the destination endpoint 120.

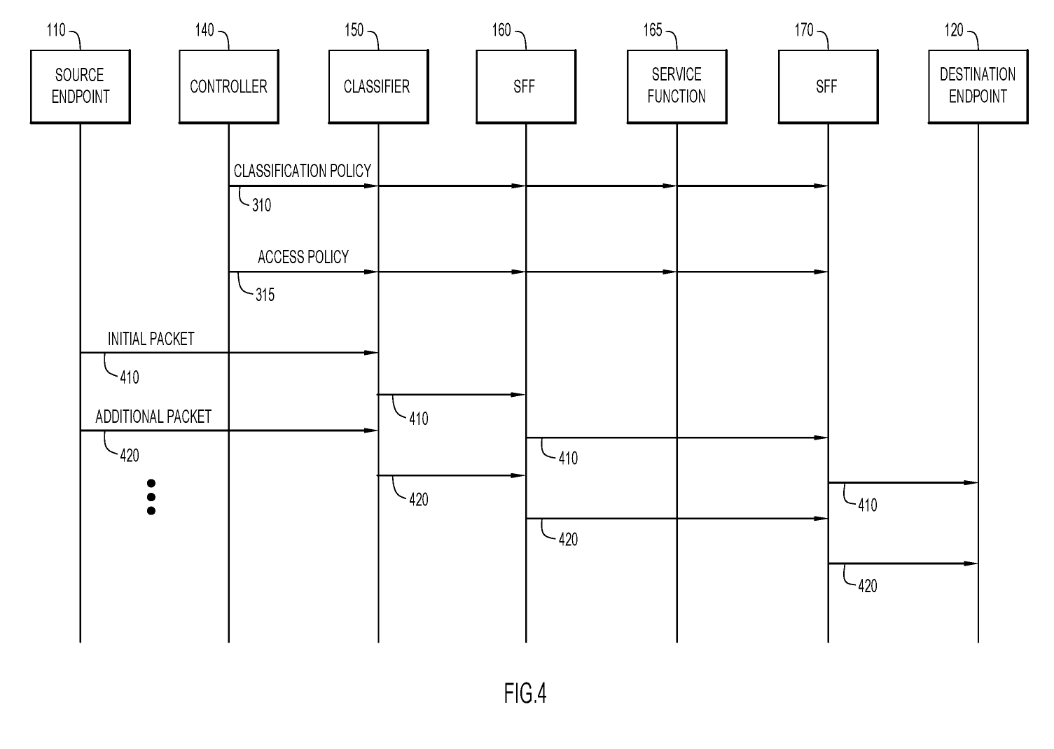

Referring now to FIG. 4, a ladder diagram is shown of messages passed in establishing an access policy 180 that bypasses the Service Function Chain system for a specific flow. As shown in FIG. 3, the controller distributes the classification policy 310 and the access control policy 315 to the classifier 150, and optionally to the SFF nodes 160 and 170. The source endpoint 110 sends the initial packet 410 of a flow from the source endpoint to the destination endpoint 120. The initial packet 410 is received by the classifier node 150, and based on the access policy 315 received from the controller 140, the classifier node 150 determines that the flow initiated by the packet 410 will be permitted to continue to the destination node 120, but will bypass the service function(s) in the Service Function Chain system 130. The classifier node 150 may determine that the flow will bypass the service function(s) based on characteristics of the initial packet 4100. For example, the access policy 315 may indicate that flows directed to the address of the destination endpoint 120 are allowed to bypass the Service Function Chain system 130.

The classifier node 150 then forwards the initial packet 410 to the destination endpoint via SFF nodes 160 and 170. Since the packet 410 is not encapsulated with a Network Service Header indicating a Service Function Path, the SFF nodes 160 and 170 do not forward the packet 410 to any service function, and the flow bypasses the Service Function Chain system 130. When an additional packet 420 of the same flow is received at the classifier 150, the classifier 150 forwards any additional packets 420 to the destination endpoint 120 in the same way as initial packet 410.

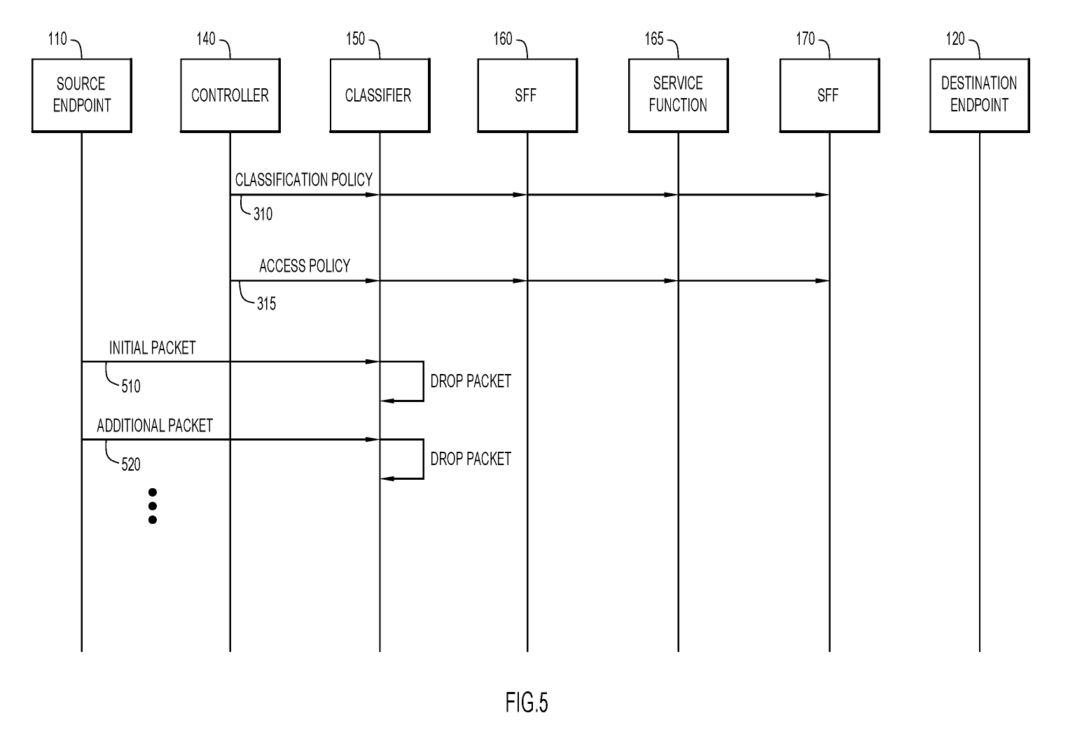

Referring now to FIG. 5, a ladder diagram is shown of messages passed in establishing an access policy 180 that drops specific flows and bypasses the Service Function Chain system. As shown in FIG. 3, the controller distributes the classification policy 310 and the access control policy 315 to the classifier 150, and optionally to the SFF nodes 160 and 170. The source endpoint 110 sends the initial packet 510 of a flow from the source endpoint to the destination endpoint 120.

Based on the access policy 315, the classifier node 150 determines that the flow associated with the initial packet 510 is not permitted to use the network resources of the Service Function Chain system 130. For example, the suspect flow may originate from a source endpoint 110 that is known to distribute malicious software. The classifier node 150 drops the initial packet 510, and prevents the packet 510 from entering the Service Function Chain system 130 or from being delivered to the destination endpoint 120. Additionally, the classifier node 150 drops any additional packet(s) 520 that is identified as being part of the same flow. In this way, the classifier node 150 protects the Service Function Chain system 130 and the destination endpoint 120 without expending resources in forwarding the flow to a service function such as a firewall.

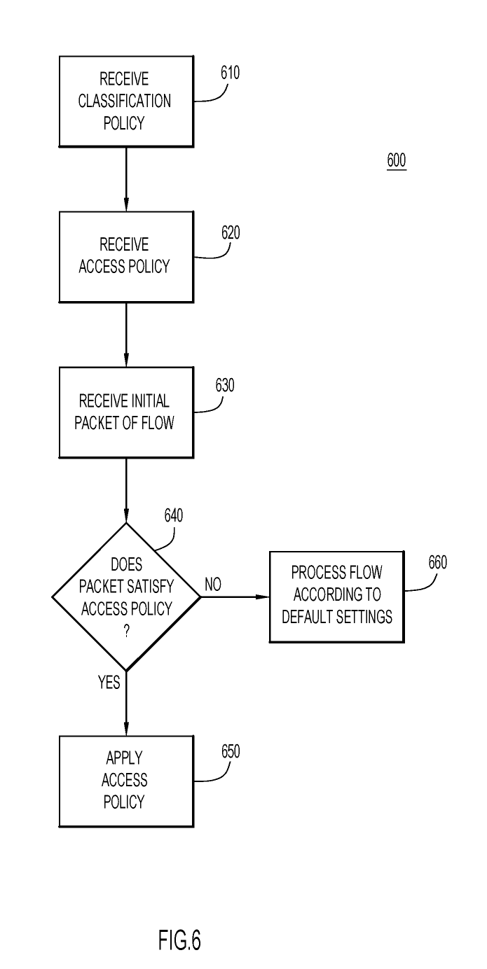

Referring now to FIG. 6, a flowchart is shown for a process 600 by which a classifier network element 150 implements an access control policy. In step 610, the classifier node 150 receives a classification policy, e.g., from the controller 140 of the Service Function Chain system 130. The classification policy identifies which Service Function Path network traffic flows will traverse in the Service Function Chain system. In step 620 the classifier node 150 receives an access policy, e.g., from the controller 140 of the Service Function Chain system 130. The access policy defines one or more criteria for determining whether a flow will be sent along a Service Function Path of the Service Function Chain system 130. In one example, the access policy determines whether a flow will be sent to all of the service functions in a Service Function Path. The access policy does not allow the classifier network element 150 to pick and choose to which service function(s) in the Service Function Path a flow will be sent. The criteria specified in the access policy may include a source address/port, a destination address/port, a protocol of the packets in the flow, QoS parameters of the flow, or any other parameters in the network stack of the packets in the flow.

In step 630, the classifier node 150 receives an initial packet of a network traffic flow from a source endpoint. The initial packet identifies various characteristics of the network traffic flow between the source endpoint and the destination endpoint, such as network addresses, port number, protocol, and/or QoS parameters. If the initial packet satisfies the criteria specified in the access policy, as determined in step 640, then the classifier node 150 applies the access policy to the network traffic flow in step 650. If the initial packet does not satisfy the criteria specified in the access policy, then the classifier node 150 processes the network traffic flow according to a default setting in step 660.

In one example, applying the access policy in step 650 may include encapsulating the packets of the network traffic flow with a Network Service Header that indicates a Service Function Path determined by the classification policy received in step 610. In another example, applying the access policy in step 650 may include forwarding the initial packet as well as any additional packets in the flow to the destination endpoint, bypassing the Service Function Chain system and any service functions therein. In a further example, applying the access policy in step 650 may include dropping the initial packet and any subsequent packets in the flow before the flow reaches any service functions or the destination endpoint.

In another example, the classifier node 150 may include default access settings that determine how to process network traffic flows that do not match the access policy received in step 620. The default settings may include sending the flow through the Service Function Chain system, bypassing the Service Function Chain system, or dropping the flow entirely.

In summary, the techniques presented herein provide for a mechanism to leverage the flexibility and elasticity advantage of virtualizing a data center by enabling a user to manage traffic redirection to service functions based on simple access policies. These techniques result in higher efficiency and control in processing noteworthy traffic flows. The techniques presented herein provide for a simple and flexible packet/flow redirection scheme. The scheme filters noteworthy traffic from the rest, allowing for efficient usage of network bandwidth without requiring increased processing/memory resources at both the network elements and service function nodes. The higher efficiency enables servicing of a higher number of flows and packets. The access policies may vary from simple host/IP-based criteria to subnets and protocol-based criteria, adding to the granularity of selecting flows. These techniques may be used for Service Provider in Mobility in data center deployments for North-South traffic (i.e., Branch to Data Center) as well as East-West traffic (i.e., within data centers).

In one form, the techniques presented herein provide for a method performed at a classifier network element in a service function chain system. The classifier network element receives a classification policy from a controller of the service function chain system. The classification policy identifies which service function path network traffic flows will traverse through the service function chain system. The classifier network element receives an access policy from the controller of the service function chain system. The access policy defines one or more criteria for determining whether network traffic flows will be sent along a service function path of the service function chain system. The classifier network element receives an initial packet of a network traffic flow from a source endpoint directed to a destination endpoint. Responsive to a determination that the initial packet of the network traffic flow satisfies the one or more criteria of the access policy, the classifier network element applies the access policy to the network traffic flow.

In another form, the techniques presented herein provide for an apparatus comprising a plurality of ports and a processor. The plurality of ports are configured to send and receive packets over a network to communicate with computing devices (physical or virtual). The processor is configured to receive, via one port among the plurality of ports, a classification policy from a controller of a service function chain system. The classification policy identifies which service function path network traffic flows will traverse through the service function chain system. The processor is further configured to receive, via the one port among the plurality of ports, an access policy from the controller of the service function chain system. The access policy defines one or more criteria for determining whether network traffic flows will be sent along a service function path of the service function chain system. The processor is configured to receive, via another port among the plurality of ports, an initial packet of a network traffic flow from a source endpoint to a destination endpoint. Responsive to a determination that the initial packet of the network traffic flow satisfies the one or more criteria of the access policy, the processor is configured to apply the access policy to the network traffic flow.

In yet another form, the techniques presented herein provide for a system comprising a controller of a service function chain system and a classifier network element in the service function chain system. The controller is configured to define an access policy that determines whether network traffic flows will be sent to a service function along a service function path. The controller is also configured to define a classification policy that identifies which service function path network traffic flows will traverse. The classifier network element is configured to receive the classification policy and the access policy from the controller. The classifier network element is also configured to receive an initial packet of a network traffic flow from a source endpoint directed to a destination endpoint. Responsive to a determination that the initial packet of the network traffic flow satisfies one or more criteria of the access policy, the classifier network element is configured to apply the access policy to the network traffic flow.

In still another form, a non-transitory computer readable storage media is provided that is encoded with instructions that, when executed by a processor, cause the processor to perform any of the methods described and shown herein.

The above description is intended by way of example only. Various modifications and structural changes may be made therein without departing from the scope of the concepts described herein and within the scope and range of equivalents of the claims.

What is claimed is:

1. A method comprising:
at a classifier network element of a service function chain system, receiving a classification policy from a controller of the service function chain system, the classification policy identifying which service function path network traffic flows will traverse;
receiving an access policy from the controller of the service function chain system, the access policy defining one or more criteria for determining whether network traffic flows will be sent along a service function path of the service function chain system;
receiving an initial packet of a network traffic flow from a source endpoint, the network traffic flow directed to a destination endpoint; and
responsive to a determination that the initial packet of the network traffic flow satisfies the one or more criteria of the access policy, applying the access policy to the network traffic flow.

2. The method of claim 1, wherein the one or more criteria for determining whether network traffic is to be sent along the service function path include one or more of a source address, a destination address, a packet protocol, a Quality of Service (QoS) attribute, or a port number.

3. The method of claim 1, wherein applying the access policy to the network traffic flow comprises forwarding the network traffic flow to a specific service function before the network traffic flow is sent to the destination endpoint.

4. The method of claim 3, wherein forwarding the network traffic flow to the specific service function comprises directing the network traffic flow to a specific service function path that includes the specific service function.

5. The method of claim 4, wherein directing the network traffic flow to the specific service function path comprises encapsulating the network traffic flow with a network service header that identifies the specific service function path.

6. The method of claim 1, wherein applying the access policy to the network traffic flow comprises forwarding the network traffic flow to the destination endpoint bypassing any service function path.

7. The method of claim 1, wherein applying the access policy to the network traffic flow comprises dropping the network traffic flow without sending the network traffic flow along any service function path.

8. An apparatus comprising:
a plurality of ports configured to send and receive packets over a network to communicate with computing devices; and
a processor configured to:
receive, via one port among the plurality of ports, a classification policy from a controller of a service function chain system, the classification policy identifying which service function path network traffic flows will traverse;
receive, via the one port of the plurality of ports, an access policy from the controller of the service function chain system, the access policy defining one or more criteria for determining whether network traffic flows will be sent along a service function path of the service function chain system;
receive, via another port among the plurality of ports, an initial packet of a network traffic flow from a source endpoint, the network traffic flow directed to a destination endpoint; and
responsive to a determination that the initial packet of the network traffic flow satisfies the one or more criteria of the access policy, apply the access policy to the network traffic flow.

9. The apparatus of claim 8, wherein the one or more criteria for determining whether network traffic is to be sent along the service function path include one or more of a source address, a destination address, a packet protocol, a Quality of Service (QoS) attribute, or a port number.

10. The apparatus of claim 8, wherein the processor is configured to apply the access policy to the network traffic flow by forwarding the network traffic flow to a specific service function before the network traffic flow is sent to the destination endpoint.

11. The apparatus of claim 10, wherein the processor is configured to forward the network traffic flow to the specific service function by directing the network traffic flow to a specific service function path that includes the specific service function.

12. The apparatus of claim 11, wherein the processor is configured to direct the network traffic flow to the specific service function path by encapsulating the network traffic flow with a network service header that identifies the specific service function path.

13. The apparatus of claim 8, wherein the processor is configured to apply the access policy to the network traffic flow by forwarding the network traffic flow to the destination endpoint bypassing any service function path.

14. The apparatus of claim 8, wherein the processor is configured to apply the access policy to the network traffic flow by dropping the network traffic flow without sending the data flow along any service function path.

15. A system comprising:
a controller configured to:
define an access policy the determines whether network traffic flows will be sent along a service function path; and
define a classification policy identifying which service function path network traffic flows will traverse; and
a network element configured to:
receive the classification policy from the controller;
receive the access policy from the controller;
receive an initial packet of a network traffic flow from a source endpoint, the network traffic flow directed to a destination endpoint; and
responsive to a determination that the initial packet of the network traffic flow satisfies one or more criteria of the access policy, apply the access policy to the network traffic flow.

16. The system of claim 15, wherein the one or more criteria of the access policy include one or more of a source address, a destination address, a packet protocol, a Quality of Service (QoS) attribute, or a port number.

17. The system of claim 15, wherein the network element is configured to apply the access policy to the data flow by forwarding the data flow to a service function before the data flow is sent to the destination endpoint.

18. The system of claim 17, wherein the network element is configured to forward the data flow to the service function by encapsulating the data flow with a network service header and directing the encapsulated data flow along a service function path that includes the service function.

19. The system of claim 15, wherein the network element is configured to apply the access policy to the data flow by forwarding the data flow to the destination endpoint bypassing any service function path.

20. The system of claim 15, wherein the network element is configured to apply the access policy to the data flow by dropping the data flow without sending the data flow to a service function along any service function path.
